(19) United States
(12) Patent Application Publication
(10) Pub. No.: US 2023/0242414 A1
(43) Pub. Date: Aug. 3, 2023

(54) WATER PURIFIER FILTER AND WATER PURIFIER COMPRISING SAME

(71) Applicant: LG ELECTRONICS INC., Seoul (KR)

(72) Inventors: Suhye WOO, Seoul (KR); Sangduck LEE, Seoul (KR); Jongpil KIM, Seoul (KR); Uiseung CHOI, Seoul (KR)

(21) Appl. No.: 17/927,203

(22) PCT Filed: Apr. 7, 2021
(86) PCT No.: PCT/KR2021/004339

§ 371 Date: Nov. 22, 2022

(30) Foreign Application Priority Data
May 22, 2020 (KR) 10-2020-0061726
May 22, 2020 (KR) 10-2020-0061728

(51) Int. Cl. C02F 1/00; B01D 39/20; B01D 29/15; B01D 29/58

(52) U.S. Cl. CPC C02F 1/003; B01D 39/2062; B01D 29/15; B01D 29/58; B01D 39/2037; C02F 2101/20

(57) ABSTRACT

A water purifier filter and a water purifier comprising same, according to the present invention, comprises: a filter housing including an inlet and an outlet; a filter module which is provided inside the filter housing to purify the water having flowed in through the inlet and then supply same to the outlet, wherein the filter module comprises a first filter member formed as a hollow tube and a second filter member made of a material different from that of the first filter member.

### TECHNICAL FIELD

The present invention relates to a filter for a water purifier, in which a carbon block is embedded, and a water purifier including the same.

### BACKGROUND ART

A water purifier refers to a device that purifies raw water such as tap water or groundwater. That is, the water purifier refers to a device for converting raw water into drinking water through various purification methods to provide the drinking water.

To generate purified water, processes such as precipitation, filtration, and sterilization may be performed, and thus, harmful substances are generally removed through these processes.

Generally, a water purifier may be provided with various filters to purify raw water. The filters may be classified into a sediment filter, an activated carbon filter, a UF hollow fiber membrane filter, an RO membrane filter, and the like according to their functions.

The sediment filter may be called a filter for precipitating contaminants or suspended materials with large particles in the raw water, and the activated carbon filter may be called a filter for adsorbing and removing contaminants with small particles, residual chlorine, volatile organic compounds or odor generating factors.

In addition, the activated carbon filter may generally be provided with two. That is, the activated carbon filter may be provided with a pre-activated carbon filter provided at a raw water-side and a post-activated carbon filter provided at a purified water-side. The post-activated carbon filter may be provided to improve the taste of water by removing odor-causing substances that mainly affect the taste of purified water.

In addition, the UF hollow fiber membrane filter and the RO membrane filter are generally used selectively.

Recently, the demand for water purifiers is increasing significantly. Therefore, there is a limitation that various requirements are generated, and it is difficult to satisfy the various requirements at the same time.

As an example, heavy metals may be removed by applying the RO membrane filter, but there is a limitation in that it is difficult to secure a flow rate of the purified water. That is, there is a limitation that it takes a lot of time to obtain a desired amount of purified water.

On the other hand, in the case of the UF hollow fiber membrane filter, a high flow rate may be secured. However, since it is difficult to remove heavy metals in water, there is a limitation in that it is difficult to use groundwater or tap water in a contaminated area as raw water.

Therefore, the removal of the heavy metals and the securing of the high flow rate are inevitably recognized as contradictory problems. This is because it is difficult to secure the high flow rate when using the RO membrane filter to remove the heavy metals, and it is difficult to remove the heavy metals when using the using the UF hollow fiber membrane filter to secure the high flow rate.

In addition, in the related art, a filter for removing heavy metals has been manufactured for the main purpose of removing seven types of heavy metals including arsenic (As), cadmium (Cd), lead (Pb), aluminum (Al), mercury (Hg), iron (Fe), and copper (Cu).

However, in recent years, a filter for removing eleventh types of heavy metals including selenium (Se), chromium (Cr), manganese (Mn), and zinc (Zn) in addition to the seven types of heavy metals is required.

However, in the case of the water purifier filter according to the related art, there are limitations in that it is insufficient to completely remove the seven kinds of heavy metals while ensuring a high flow rate, as well as serenium (Se), chromium (Cr), manganese (Mn), zinc (Zn) etc. in water are not removed at all.

In addition, in the case of the related art, there is a limitation in that a particle size of a binder mixed in the filter is large to cause flow resistance, and a mixing amount of the binder occupies a large proportion, and permeability of water is lowered. That is, there is a limitation in that the effective water purification amount is lowered.

In addition, in the case of the related art, a mixing ratio of the activated carbon and the heavy metal removal material mixed in the filter is not sufficient, there is a limitation that the heavy metal removal rate is limited.

### DISCLOSURE OF THE INVENTION

### Technical Problem

The present invention provides a filter for a water purifier which is capable of effectively removing heavy metals in water, which include selenium (Se), chromium (Cr), manganese (Mn), and zinc (Zn) in water, and a water purifier including the same.

The present invention provides a filter for a water purifier which is capable of removing heavy metals such as lead, mercury, arsenic, iron, aluminum, copper and cadmium in water while securing a treatment capacity, and a water purifier including the same.

The present invention provides a filter for a water purifier which is capable of removing at least nine kinds of heavy metals and a water purifier including the same.

The present invention provides a filter for a water purifier which is capable of being directly applied to an existing water purifier without changing a shape or arrangement structure of a filter applied to the water purifier, and a water purifier including the same.

The present invention provides a filter for a water purifier in which heterogeneous filters are disposed in a filter housing in a transverse direction to reduce a volume of the filters, thereby improving space utilization, and a water purifier including the same.

The present invention provides a filter for a water purifier in which heterogeneous filters are disposed in a filter housing in a longitudinal direction to reduce a volume of the filters, thereby improving space utilization, and a water purifier including the same.

### Technical Solution

A filter for a water purifier according to the present invention includes a filter housing provided with an inlet and an outlet, and a filter module provided in the filter housing to purify water introduced through the inlet, thereby supplying the purified water to the outlet.

According to an embodiment of the present invention, the filter module includes a first filter member provided in a hollow tube shape, and a second filter member disposed outside the first filter member to surround an outer surface of the first filter member and made of a material different from that of the first filter member.

The first filter member and the second filter member may be provided as a hollow first carbon block and a hollow second carbon block, respectively.

An outer diameter of the first carbon block and an inner diameter of the second carbon block may be the same.

The first carbon block and the second carbon block may have composition ratios different from each other.

The first carbon block may be prepared by mixing activated carbon, a binder, ferric hydroxide, and titanium oxide.

The first carbon block may be prepared by containing 25% to 35% by weight of the activated carbon, 13% to 23% by weight of the binder, 10% to 20% by weight of the ferric hydroxide, and 32% to 42% by weight of the titanium oxide.

The first carbon block may be prepared by containing 10% to 20% by weight of the activated carbon, 13% to 23% by weight of the binder, 10% to 57% by weight of the ferric hydroxide, and 10% to 57% by weight of the titanium oxide.

The second carbon block may be prepared by mixing activated carbon, a binder, ferric hydroxide, titanium oxide, and zero valent iron.

The second carbon block may be prepared by containing 25% to 35% by weight of the activated carbon, 13% to 23% by weight of the binder, 1% to 10% by weight of the ferric hydroxide, 1% to 10% by weight of the titanium oxide, and 37% to 47% by weight of the zero valent iron.

The second carbon block may be prepared by containing 23% to 33% by weight of the activated carbon, 13% to 23% by weight of the binder, 8% to 46% by weight of the ferric hydroxide, and 8% to 46% by weight of the titanium oxide.

The first filter member may be provided as a hollow carbon block, and the second filter member may be provided as an anion exchange resin nonwoven fabric configured to surround an outside of the carbon block.

The carbon block may be prepared by containing 20% to 28% by weight of the activated carbon, 13% to 23% by weight of the binder, 14% to 24% by weight of the ferric hydroxide, and 33% to 43% by weight of the titanium oxide.

A filter for a water purifier according to the present invention includes a first filter including a first filter housing provided with a first inlet and a first outlet and a third filter module provided in the first filter housing to purify water introduced through the first inlet, thereby supplying the purified water to the second outlet, and a second filter including a second filter housing provided with a second inlet and a second outlet and a fourth filter module provided in the second filter housing to purify water introduced through the second inlet thereby supplying the purified water to the second outlet.

The first filter and the second filter may be disposed in series, and the water discharged through the first outlet may be introduced to the second inlet.

The third filter module may include a hollow third carbon block prepared by mixing activated carbon, a binder, ferric hydroxide, titanium oxide, and zero valent iron.

The third carbon block may be prepared by containing 25% to 35% by weight of the activated carbon, 13% to 23% by weight of the binder, 5% to 15% by weight of the iron hydroxide, 18% to 28% by weight of the titanium oxide, and 10% to 20% by weight of the zero valent iron.

The fourth filter module may include a hollow fourth carbon block prepared by mixing activated carbon, a binder, iron hydroxide, and titanium oxide.

The fourth carbon block may be prepared by containing 18% to 28% by weight of the activated carbon, 13% to 23% by weight of the binder, 15% to 30% by weight of the iron hydroxide, and 30% to 45% by weight of the titanium oxide.

According to another embodiment of the present invention, an inner space of the filter housing includes a first space portion defined in a lower portion thereof so that the water introduced into the filter housing is introduced, and a second space portion defined above the first space portion so that the water passing through the first space portion is introduced.

The filter module includes a third filter member disposed in the first space portion, and a fourth filter member provided in the second space portion.

The third filter member and the fourth filter member may be provided as a hollow fifth carbon block and a hollow sixth carbon block, respectively.

The third carbon block and the fourth carbon block may have composition ratios different from each other.

An outer diameter of the third carbon block may be greater than an outer diameter of the fourth carbon block.

The third carbon block may be prepared by mixing activated carbon, a binder, iron hydroxide, titanium oxide, and zero valent iron.

The third carbon block may be prepared by containing 18% to 28% by weight of the activated carbon, 13% to 23% by weight of the binder, 9% to 15% by weight of the iron hydroxide, 18% to 28% by weight of the titanium oxide, and 15% to 25% by weight of the zero valent iron.

The fourth carbon block may be prepared by containing 20% to 30% by weight of the activated carbon, 13% to 23% by weight of the binder, 10% to 20% by weight of the iron hydroxide, and 37% to 47% by weight of the titanium oxide.

Each of the third carbon block and the fourth carbon block may be prepared by mixing activated carbon, a binder, iron hydroxide, and titanium oxide.

The third carbon block may be prepared by containing 20% to 30% by weight of the activated carbon, 13% to 23% by weight of the binder, 29% to 39% by weight of the iron hydroxide, and 18% to 28% by weight of the titanium oxide.

The fourth carbon block may be prepared by containing 20% to 30% by weight of the activated carbon, 13% to 23% by weight of the binder, 12% to 22% by weight of the iron hydroxide, and 35% to 45% by weight of the titanium oxide.

The first space portion may be filled with an anion exchange resin in the form of particles, and the carbon block may be accommodated in the second space portion.

The carbon block may be prepared by containing 25% to 30% by weight of the activated carbon, 13% to 23% by weight of the binder, 27% to 37% by weight of the iron hydroxide, and 25% to 30% by weight of the titanium oxide.

An inner cover configured to accommodate the fourth filter member in an inner space thereof may be disposed inside the filter housing.

An inner cover configured to accommodate the third filter member and the fourth filter member in an inner space thereof may be disposed inside the filter housing, and the inner cover may serve as an intermediate wall configured to partition the first space portion from the second space portion.

A water purifier according to the present invention include the above-described filter of the water purifier.

### Advantageous Effects

According to the present invention, there may be the effect capable of removing the heavy metals such as lead, mercury, arsenic, iron, aluminum, copper, and cadmium in water while securing the treatment capacity.

According to the present invention, there may be the effect capable of removing at least nine kinds of heavy metals.

In addition, there may be the effect capable of reliably removing the heavy metals in water containing chromium (Cr), selenium (Se), manganese (Mn), and zinc (Zn) in water.

According to the present invention, there may be the effect that the water purification process is performed several times by the plurality of filters to more reliably remove the various foreign substances in addition to the heavy metals.

According to the present invention, there may be the effect that, since only the material of the filter is changed, and the shape or arrangement structure of the filter applied to the water purifier is not changed, the filter is capable of being directly applied to the existing water purifier.

According to the present invention, there may be the effect that the heterogeneous filters are in the one filter housing in the transverse to reduce the volume of the filters, thereby improving the space utilization and more realizing the slimness of the water purifier.

According to the present invention, there may be the effect that the heterogeneous filters are in the one filter housing in the longitudinal direction to reduce the volume of the filters, thereby improving the space utilization and more realizing the slimness of the water purifier.

### BRIEF DESCRIPTION OF THE DRAWINGS

FIG. 1 is a water pipe diagram of a water purifier according to an embodiment of the present invention.

FIG. 2 is a conceptual view of a filter assembly that is a portion of components of the present invention.

FIG. 3 is a cross-sectional view of a carbon filter according to an embodiment of the present invention.

FIG. 4 is a view illustrating a mechanism for removing contaminants of zero valent iron.

FIG. 5 is a view illustrating a mechanism for removing heavy metals of zero valent iron.

FIG. 6 is a cross-sectional view of a carbon filter according to another embodiment of the present invention.

FIG. 7 is a cross-sectional view of a carbon filter according to another embodiment of the present invention.

FIG. 8 is a view illustrating a mechanism in which chromium (Cr) and selenium (Se) are removed from an anion exchange resin nonwoven fabric.

FIG. 9 is a cross-sectional view illustrating a first filter and a second filter according to an embodiment of the present invention.

FIG. 10 is a cross-sectional view of a composite filter according to another embodiment of the present invention.

FIG. 11 is a cross-sectional view illustrating a composite filter according to further another embodiment of the present invention.

FIG. 12 is a block diagram for explaining a process of preparing a carbon block applied to the filter according to the present invention.

### MODE FOR CARRYING OUT THE INVENTION

Hereinafter, specific embodiments will be described in detail with reference to the accompanying drawings. The invention may, however, be embodied in many different forms and should not be construed as being limited to the embodiments set forth herein, and a person of ordinary skill in the art, who understands the spirit of the present invention, may readily implement other embodiments included within the scope of the same concept by adding, changing, deleting, and adding components; rather, it will be understood that they are also included within the scope of the present invention.

The drawings attached to the following embodiments are embodiments of the scope of the invention, but to facilitate understanding within the scope of the present invention, in the description of the fine portions, the drawings may be expressed differently according to the drawings, and the specific portions may not be displayed according to the drawings, or may be exaggerated according to the drawings.

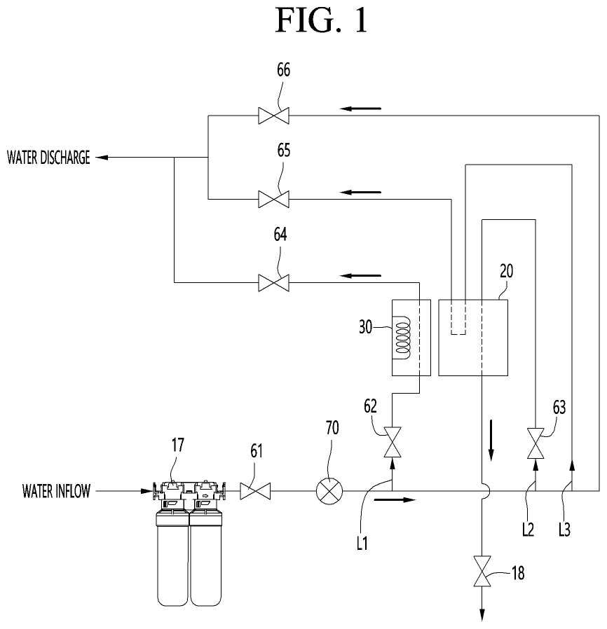

FIG. 1 is a water pipe diagram of a water purifier according to an embodiment of the present invention.

A water purifier according to the present invention may be configured to purify water directly supplied from an external water source to cool or heat the water to be dispensed. For example, the water purifier may be a direct type hot and cold water purifier.

Here, the direct type water purifier represents a water purifier in which water is dispensed when a user performs a water dispensing operation without having a water tank in which purified water is stored.

In addition, the water purifier according to the present invention may be formed integrally with the refrigerator.

In addition, the water purifier according to the present invention may be provided with an undersink-type water purifier in which a main body is installed under a sink, and a water outlet is installed outside the sink.

Referring to FIG. 1, in the water purifier according to an embodiment of the present invention, a water supply line L may be disposed from a water supply source to the water outlet of the water purifier, and various valves and water purifying components may be connected to the water supply line L.

In more detail, the water supply line is connected to the water supply source, e.g., a faucet in the home, and a filter assembly 17 is disposed at any point of the water supply line to filter foreign substances contained in drinking water supplied from the water supply source.

Also, a water supply valve 61 and a flow rate sensor 70 are successively disposed on the water supply line L connected to an outlet end of the filter assembly 17. Thus, when an amount of supplied water, which is detected by the flow rate sensor 70, reaches a set flow rate, the water supply valve 61 may be controlled to be closed.

Also, a water supply line L1 for supplying hot water, a water supply line L3 for supplying cold water, and a water supply line L2 for supplying cold water may be branched from any points of the water supply line L extending from the outlet end of the water flow sensor 70.

Also, a purified water dispensing valve 66 may be mounted on an end of the water supply line L extending from the outlet end of the flow rate sensor 70, and a hot water dispensing valve 64 may be mounted on an end of the water supply line L1 for supplying the hot water. Also, a cold water dispensing valve 65 may be mounted on an end of the water supply line L3 for supplying the cold water, and a cold water valve 63 may be mounted at any point of the water supply line L2 for supplying the cold water. The cold water valve 63 adjusts an amount of cold water to be supplied to the cold water generating unit 20.

Also, all the water supply lines extending from outlet ends of the hot water dispensing valve 64, the cold water dispensing valve 65, and the purified water dispensing valve 66 are connected to the water outlet. Also, as illustrated in the drawing, the purified water, the cold water, and the hot water may be dispensed through a single dispensing hole. In some case, the purified water, the cold water, and the hot water may be dispensed through independent dispensing holes, respectively.

Hereinafter, a process of supplying cold water and hot water will be described.

First, in case of cold water, when the cold water valve 63 is opened to supply cold water to the cold water generating unit 20, water of the water supply line L3 for supplying cold water, which passes through the cold water generating unit 20, may be cooled by coolant to generate cold water.

Here, a refrigerant cycle for cooling the coolant may be provided in the water supply line L2 for supplying the cold water. The refrigerant cycle may include a compressor, a condenser, an expansion valve, and an evaporator.

Thereafter, when a cold water selection button of the manipulation display unit is pushed to open the cold water dispensing valve 65, the cold water may be dispensed through the water outlet.

In case of hot water, water flowing along the water supply line L1 for supplying the hot water may be heated by the hot water heater 30 to generate the hot water. When the hot water selection button of the manipulation display unit is pushed to open the hot water dispensing valve 64, the hot water may be dispensed through the water outlet.

The water purifier having the above-described configuration according to an embodiment of the present invention includes at least one water purifier filter to generate purified water from raw water. The water purifier filter will be described with reference to following description.

Hereinafter, the filter for the water purifier according to an embodiment of the present invention will be described.

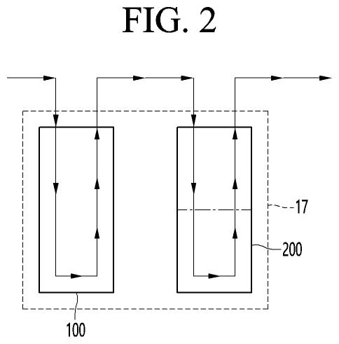

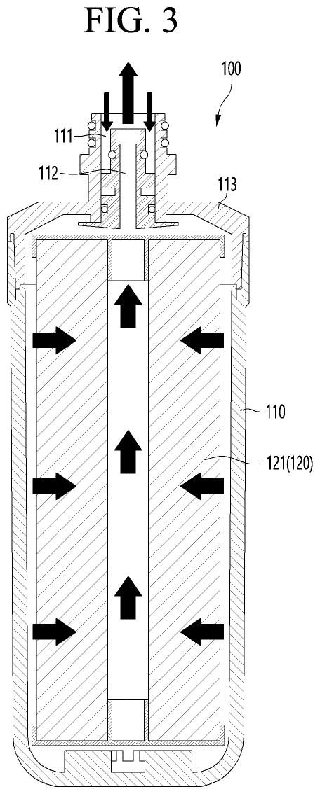

FIG. 2 is a conceptual view of a filter assembly that is a portion of components of the present invention. Also, FIG. 3 is a cross-sectional view of a carbon filter according to an embodiment of the present invention.

A filter assembly 17 according to the present invention may include at least one filter 100.

In addition, the filter assembly 17 according to the present invention may include a plurality of filters 100 and 200.

Referring to FIGS. 2 to 3, a filter for a water purifier (hereinafter, referred to as a filter assembly) according to an embodiment of the present invention may include a carbon filter 100 including a carbon block 121 having a hollow tube shape.

First, the carbon filter 100 includes a filter housing 110 and a filter module 120.

The filter housing 110 includes an inlet 111 and an outlet 112. That is, water required to be purified is introduced through the inlet 111, and the purified water is discharged through the outlet 112. Thus, water is purified by the filter module 120 disposed between the inlet 111 and the outlet 112 while flowing between the inlet 111 and the outlet 112.

In addition, the filter housing 110 may define a space in which the filter module 120 is accommodated and may include an upper cap 113 in which the inlet 111 and the outlet 112 are provided. In this case, a space portion of the filter housing 110 may communicate with the outside through the inlet 111 and the outlet 112 of the upper cap 113

When the upper cap 113 is provided as described above, the filter module 120 may be easily mounted in the space portion of the filter housing 110 by opening the upper cap 113, and thus, the filter module 120 may be easily replaced.

Water introduced into the filter housing 110 through the inlet 111 may be purified while passing through the filter module 120. That is, foreign substances (e.g., heavy metals) contained in raw water such as tap water may be removed while passing through the filter module 120.

According to the present embodiment, a filter for a water purifier that is excellent in removing the heavy metals in water, and a water purifier having the same may be provided.

For example, the filter module 120 may be provided with a carbon block 121 prepared by mixing activated carbon, a binder, iron hydroxide, and titanium oxide to mold a mixture in a hollow block shape.

As another example, the filter module 120 may be provided with the carbon block 121 prepared by mixing activated carbon, a binder, iron hydroxide, titanium oxide, and zero valent iron to mold a mixture in a hollow block shape.

The titanium oxide may include titanium dioxide (TiO₂) or titanium (Na₄TiO₄).

The activated carbon, the binder, the iron hydroxide, and the titanium oxide may be mixed in various composition ratios.

In addition, the activated carbon, the binder, the iron hydroxide, the titanium oxide, and the zero valent iron may be mixed in various composition ratios.

For example, the carbon block 121 is prepared by containing 25% to 35% by weight of the activated carbon, 13% to 23% by weight of the binder, 5% to 15% by weight of the iron hydroxide, 18% to 28% by weight of the titanium oxide, and 10% to 20% by weight of the zero valent iron.

The titanium oxide may include titanium dioxide or titanium tetraoxide.

In general, the titanium oxide has a functional group in which a plurality of oxygen (O) is covalently bonded to one titanium (Ti).

For example, sodium orthotitanate (Na₄TiO₄), which is a type of titanium oxide, may remove (ion adsorption) heavy metals in water through a chemical reaction such as following Formula (1).

Na₄TiO₄+2Me⁺⁺→Me₂TiO₄+4Na⁺ (1)

In Formula (1), ‘Me’means a heavy metal, and the heavy metal is dissolved in water in the form of a water-soluble compound.

Due to the chemical reaction between the water-soluble heavy metal compound and the sodium orthotitanate (Na₄TiO₄), purified water from which the heavy metal (Me) is removed is discharged to the outside of the filter housing 110 through the outlet 112.

For example, ‘Me’may correspond to cadmium (Cd).

In this case, sodium orthotitanate (Na₄TiO₄) may remove (ion adsorption) cadmium (Cd) in water through a chemical reaction such as following Formula (2).

Na₄TiO₄+2Cd⁺⁺→Cd₂TiO₄+4Na⁺ (2)

The titanium oxide may have a granular or powder form and may be mixed with the materials of the carbon block 121 to constitute the carbon block 121.

Therefore, when the water containing the heavy metal passes through the filter module 120, the heavy metal in the water may be removed.

In addition, the titanium dioxide may remove (ion adsorption) manganese in water through a chemical reaction such as following Formula (3).

Mn²⁺+Ti₂O(OH)₂→Ti₂O(O₂Mn)+2H⁺ (3)

In addition, the titanium dioxide may remove (ion adsorption) zinc in water through a chemical reaction such as following Formula (4).

Zn²⁺+Ti₂O(OH)₂→Ti₂O(O₂Zn)+2H⁺ (4)

In addition, the titanium dioxide may remove (ion adsorption) chromium and serenium in water through a chemical reaction such as following Formula (5).

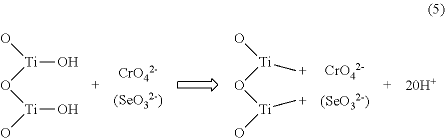

In addition, the carbon block 121 may include ferric hydroxide.

Here, the ferric hydroxide may mean a synthetic ferric hydroxide (α-FeOOH) compound.

The synthetic ferric hydroxide (α-FeOOH) compound may include a functional group represented by following Formula (6).

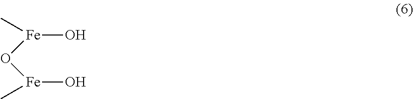

That is, the synthetic ferric hydroxide (α-FeOOH) compound may include a functional group in which each of a plurality of iron (Fe) is bonded to a hydroxyl group (—OH), and each iron (Fe) is ionic or covalently bonded to one oxygen (O).

As an example of such a synthetic ferric hydroxide (α-FeOOH) compound, the trade name ‘Bayoxide E33HCF’provided by LanXess may be used.

The synthetic ferric hydroxide (α-FeOOH) compound may remove heavy metals in water through a chemical reaction such as following Formula (7).

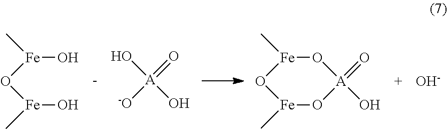

Here, ‘A’means a heavy metal, and the heavy metal may be dissolved in water in the form of a water-soluble compound.

As described above, when the water-soluble heavy metal compound and the synthetic ferric hydroxide (α-FeOOH) compound undergo a chemical reaction, water and hydroxide ions are generated. In addition, a heavy metal A has a strong ionic or covalent bond with the synthetic ferric hydroxide (α-FeOOH) compound. Therefore, the removed heavy metal A is prevented from being dissolved in water again. In addition, the purified water from which the heavy metal A is removed through the filter module 120 is discharged to the outside of the filter housing 110 through the outlet 112. For example, the heavy metal A may be ‘arsenic’.

For reference, the ferric hydroxide may remove cadmium (Cd) in water through a chemical reaction such as following Formula (8).

2Fe²⁺+Cd²⁺+4OH⁻−>CdFe₂O₄+2H₂ (8)

In addition, the ferric hydroxide may remove chromium and serenium in water through a chemical reaction such as following Formula (9).

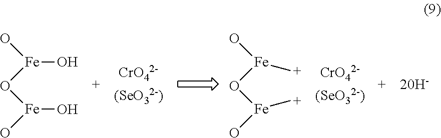

The synthetic ferric hydroxide (α-FeOOH) compound may have a granular or powder form and may be mixed with a binder as a material of the carbon block 121 to constitute the carbon block 121.

In addition, the carbon block 121 may further include zero valent iron.

The zero valent iron ZVI means a reactive metal having a standard redox potential (E0=−0.44V). In addition, the zero-valent iron is an effective reduction that reacts well with oxidized heavy metals such as hexavalent chromium.

In addition, oxidation reaction in water is carried out as in following Formula 10 to Formula 13 of the zero valent iron.

2FeO_{(S)}+O₂+2H₂O→2Fe²⁺+4OH⁻ (10)

4Fe²⁺+O₂+2H₂O→4Fe³⁺+4OH⁻ (11)

Fe²⁺+2OH^{-→Fe(OH)}_{2(S)} (12)

Fe³⁺+2OH⁻→Fe(OH)_{3(S)} (13)

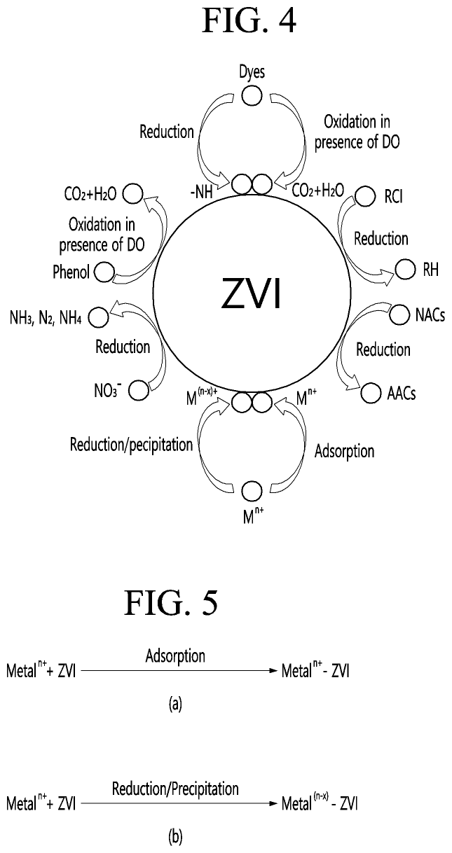

FIG. 4 is a view illustrating a mechanism for removing contaminants of the zero valent iron. FIG. 5 is a view illustrating a mechanism for removing heavy metals of the zero valent iron.

The zero valent iron may remove contaminants and heavy metals by the same mechanism as in FIGS. 4 and 5.

In addition, the carbon block 121 may further include activated carbon.

The activated carbon may be provided in the form of granular or powder. As described above, when the carbon block 121 includes activated carbon, the carbon block 121 may effectively remove heavy metals in water and also residual chlorine components in water. Thus, the taste of water may also be improved.

In addition, chloroform (CHCL₃) in water may be effectively removed by the activated carbon.

The binder connects activated carbon, titanium oxide, and ferric hydroxide to each other and is mixed to give rigidity.

Due to the configuration of the binder, activated carbon, titanium oxide, and ferric hydroxide may be processed in the form of a block having rigidity.

For example, the filter module 120 may be provided by mixing the above-mentioned materials uniformly and then putting the mixture in a mold to heating the mixture. The binder (e.g., polyethylene (PE)) is melted by being heated in the mold, and activated carbon, titanium oxide, and ferric hydroxide are coupled. Thus, the carbon block 121 in the form of the block having rigidity as a whole may be provided.

In general, in the water purifier, several filters are already installed to remove heavy metals and various foreign substances in the water. If the several filters are installed, water purification performance may be secured, but a flow rate of the purified water may be inevitably reduced.

Since a space in which the filter is installed is limited in the existing water purifier, it is not easy to add a new filter, and each filter (e.g., activated carbon filter) installed in the water purifier basically has an individual function to improve the water purification performance, and thus, it is not preferable that the existing filter is omitted to add a new filter.

However, in the case of the present invention, the carbon block 121 may be provided by mixing activated carbon, titanium oxide, and ferric hydroxide.

Therefore, even heavy metals in water may be removed without increasing in number of filters while maintaining the unique functions and effects of the activated carbon filter installed in the existing water purifier. In addition, since the number of filters does not increase, the flow rate of the purified water may be prevented from decreasing.

In this embodiment, the carbon block 121 may have an outer diameter of 48 mm to 57 mm. In addition, the carbon block 21 may have an inner diameter of 12 mm to 15 mm. In addition, the carbon block 21 may have a length of 145 mm to 210 mm.

In addition, the carbon block 121 may have a weight of 160 g to 310 g. In this case, the carbon block 121 may be prepared by containing 40 g to 109 g of activated carbon, 21 g to 71 g of a binder, 8 g to 47 g of ferric hydroxide, 29 g to 87 g of titanium oxide, and 16 g to 62 g of zero valent iron.

The filter for the water purifier according to the present invention may include a plurality of carbon filters 100 which are illustrated in FIG. 3 and disposed in series.

According to the present invention as described above, as raw water introduced into the filter housing 110 passes through the block 121, heavy metals may be removed, and thus, the water may be purified.

### First Embodiment

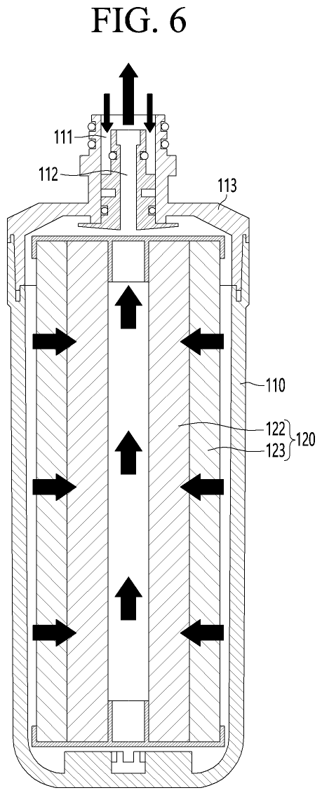

FIG. 6 is a cross-sectional view of a carbon filter according to another embodiment of the present invention.

Referring to FIG. 6, a filter module 120, which is a main component of the present invention, may include a plurality of carbon blocks 122 and 123.

For example, the carbon blocks 122 and 123 include a first carbon block 122 disposed inside, and a second carbon block 123 disposed to surround the outside of the first carbon block 122.

In this case, an outer diameter of the first carbon block 122 and an inner diameter of the second carbon block 123 may be the same.

In addition, the first carbon block 122 and the second carbon block 123 may have different composition materials and composition ratios.

For example, the first carbon block 122 and the second carbon block 123 may be prepared by mixing activated carbon, a binder, ferric hydroxide, and titanium oxide.

In this case, the first carbon block 122 may be prepared to containing 110% to 20% by weight of the activated carbon, 13% to 23% by weight of the binder, 10% to 57% by weight of the iron hydroxide, and 10% to 57% by weight of the titanium oxide.

In addition, the second carbon block 123 may be prepared by containing 23% to 33% by weight of the activated carbon, 13% to 23% by weight of the binder, 8% to 46% by weight of the iron hydroxide, and 8% to 46% by weight of the titanium oxide.

As another example, the first carbon block 122 may be prepared by mixing activated carbon, binder, ferric hydroxide, and titanium oxide, and the second carbon block 123 may be prepared by mixing activated carbon, binder, ferric hydroxide, titanium oxide, and zero valent iron.

In this case, the first carbon block 122 may be prepared by containing 25% to 35% by weight of the activated carbon, 13% to 23% by weight of the binder, 10% to 20% by weight of the iron hydroxide, and 32% to 42% by weight of the titanium oxide.

In addition, the second carbon block 123 may be prepared by containing 25% to 35% by weight of the activated carbon, 13% to 23% by weight of the binder, 1% to 10% by weight of the iron hydroxide, 1% to 10% by weight of the titanium oxide, and 37% to 47% by weight of the zero valent iron.

The first carbon block 122 may have an outer diameter of 35 mm to 48 mm, an inner diameter of 12 mm to 15 mm, and a length of 148 mm to 210 mm, and the second carbon block 123 may have an outer diameter of 48 mm to 57 mm, an inner diameter of 35 mm to 48 mm, and a length of 148 mm to 210 mm.

As another example, the first carbon block 122 may have a weight of 80 g to 200 g. In this case, the first carbon block 122 may be prepared by containing 20 g to 70 g of activated carbon, 10 g to 46 g of a binder, 8 g to 40 g of ferric hydroxide, and 26 g to 84 g of titanium oxide.

In addition, the second carbon block 123 may have a weight of 60 g to 190 g. In this case, the carbon block 121 may be prepared by containing 15 g to 67 g of activated carbon, 8 g to 44 g of a binder, 1 g to 19 g of ferric hydroxide, 1 g to 19 g of titanium oxide, and 37 g to 47 g of zero valent iron.

The first carbon block 122 may have an outer diameter of 35 mm to 45 mm, an inner diameter of 12 mm to 15 mm, and a length of 145 mm to 210 mm, and the second carbon block 123 may have an outer diameter of 45 mm to 55 mm, an inner diameter of 35 mm to 45 mm, and a length of 145 mm to 210 mm.

The filter for the water purifier according to the present invention may include a plurality of carbon filters 100 which are illustrated in FIG. 6 and disposed in series.

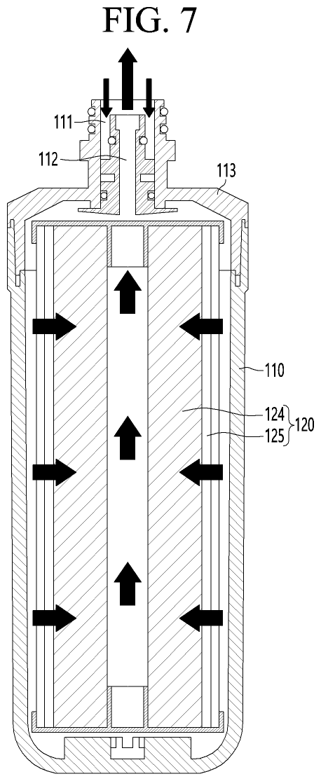

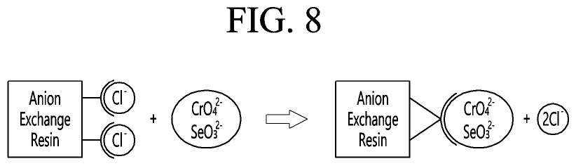

FIG. 7 is a cross-sectional view of a carbon filter according to another embodiment of the present invention. FIG. 8 is a view illustrating a mechanism in which chromium (Cr) and selenium (Se) are removed from an anion exchange resin nonwoven fabric.

Referring to FIG. 7, a carbon filter 100 may further include a carbon block 124 and an anion exchange resin nonwoven fabric 125 surrounding the outside of the carbon block 124.

When the anion exchange resin nonwoven fabric 125 is provided outside the carbon block 124 as described above, raw water introduced into the carbon filter 100 passes through the anion exchange resin nonwoven fabric 125 and then passes through the carbon block 124.

When the raw water passes through the anion exchange resin nonwoven fabric 125 as described above, heavy metals such as chromium (Cr) and serenium (Se) in the water may be removed through ion exchange as illustrated in FIG. 8.

Here, the anion exchange resin nonwoven fabric 125 may be provided in multiple layers to improve heavy metal removal efficiency.

For example, the carbon block 124 may be prepared by containing 20% to 28% by weight of the activated carbon, 13% to 23% by weight of the binder, 14% to 24% by weight of the iron hydroxide, and 33% to 43% by weight of the titanium oxide.

As another example, the carbon block 124 may have a weight of 160 g to 300 g. In this case, the first carbon block 122 may be prepared by containing 32 g to 84 g of activated carbon, 21 g to 69 g of a binder, 22 g to 72 g of ferric hydroxide, and 53 g to 129 g of titanium oxide.

The carbon block 124 may have an outer diameter of 45 mm to 54 mm, an inner diameter of 12 mm to 15 mm, and a length of 145 mm to 210 mm.

According to the above description, raw water introduced into the carbon filter 100 sequentially passes through the anion exchange resin nonwoven fabric 125 and the carbon block 124 and then is discharged to the outside of the carbon filter 100.

The filter for the water purifier according to the present invention may include a plurality of carbon filters 100 which are illustrated in FIG. 7 and disposed in series.

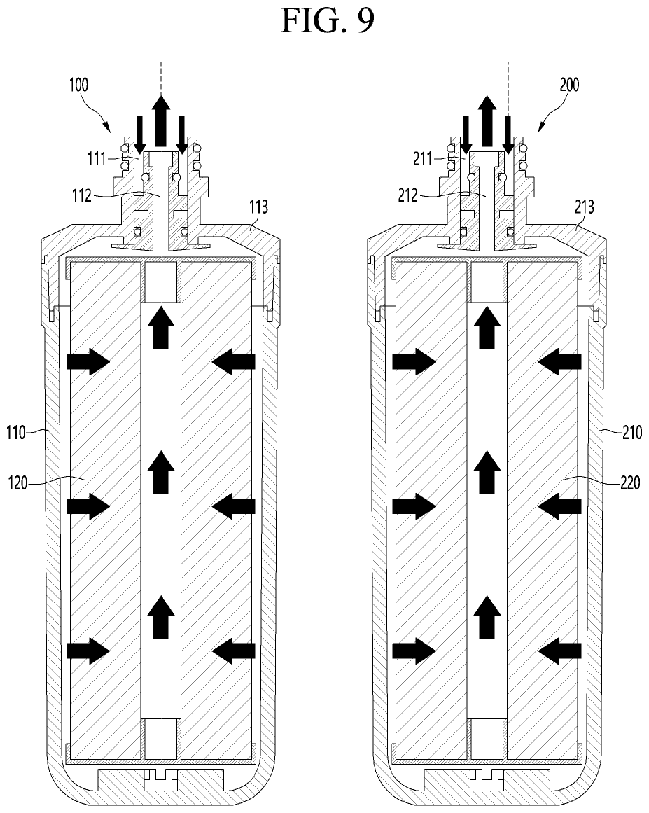

FIG. 9 is a cross-sectional view illustrating a first filter and a second filter according to an embodiment of the present invention.

Referring to FIG. 9, the filter according to the present invention includes a first filter 100 and a second filter 200, which are disposed in series based on a flow direction of water.

First, the first filter 100 includes a first filter housing 110 having a first inlet 111 and a first outlet 112 and a third filter module 120 provided in the first filter housing 110 to purify water introduced through the first inlet 111, thereby supplying the purified water to the second outlet 112.

In addition, the first filter housing 110 may define a space portion in which the third filter module 120 is accommodated and may include a first upper cap 113 in which the first inlet 111 and the first outlet 112 are provided. In this case, the space portion of the first filter housing 110 may communicate with the outside through the first inlet 111 and the first outlet 112 of the first upper cap 113.

When the first upper cap 113 is provided as described above, the third filter module 120 may be easily mounted in the space portion of the first filter housing 110 by opening the first upper cap 113, and thus, the third filter module 120 accommodated in the first filter housing 110 may be easily replaced.

Water introduced into the first filter housing 110 through the first inlet 111 may be purified while passing through the third filter module 120. That is, foreign substances (e.g., heavy metals) included in raw water such as tap water may be removed while passing through the third filter module 120.

The second filter 200 includes a second filter housing 210 having a second inlet 211 and a second outlet 212 and a fourth filter module 220 provided in the second filter housing 210 to purify water introduced through the second inlet 211, thereby supplying the purified water to the second outlet 212.

In addition, the second filter housing 210 may define a space portion in which the fourth filter module 220 is accommodated and may include a second upper cap 213 in which the second inlet 211 and the second outlet 212 are provided. In this case, the space portion of the second filter housing 210 may communicate with the outside through the second inlet 211 and the second outlet 212 of the second upper cap 213.

When the second upper cap 213 is provided as described above, the fourth filter module 220 may be easily mounted in the space portion of the second filter housing 210 by opening the second upper cap 213, and thus, the fourth filter module 220 accommodated in the second filter housing 210 may be easily replaced.

Water introduced into the second filter housing 210 through the second inlet 211 may be purified while passing through the fourth filter module 220. That is, foreign substances (e.g., heavy metals) included in raw water such as tap water may be removed while passing through the fourth filter module 220.

In addition, the first filter 100 and the second filter 200 are disposed in series, and the water discharged through the first outlet 112 is introduced into the second inlet 211.

The third filter module may include a hollow third carbon block prepared by mixing activated carbon, a binder, ferric hydroxide, titanium oxide, and zero valent iron.

The third carbon block may be prepared by containing 25% to 35% by weight of the activated carbon, 13% to 23% by weight of the binder, 5% to 15% by weight of the ferric hydroxide, 18% to 28% by weight of the titanium oxide, and 10% to 20% by weight of the zero valent iron.

As another example, the third carbon block may have a weight of 160 g to 310 g. In this case, the carbon block 121 may be prepared by containing 40 g to 109 g of activated carbon, 21 g to 71 g of a binder, 8 g to 47 g of ferric hydroxide, 29 g to 87 g of titanium oxide, and 16 g to 62 g of zero valent iron.

The third carbon block may have an outer diameter of 48 mm to 57 mm, an inner diameter of 12 mm to 15 mm, and a length of 145 mm to 210 mm.

The fourth filter module 220 may be provided as a hollow fourth carbon block prepared by mixing activated carbon, a binder, ferric hydroxide, and titanium oxide.

The fourth carbon block may be prepared by containing 18% to 28% by weight of the activated carbon, 13% to 23% by weight of the binder, 15% to 30% by weight of the ferric hydroxide, and 30% to 45% by weight of the titanium oxide.

As another example, the fourth carbon block may have a weight of 190 g to 330 g. In this case, the first carbon block 122 may be prepared by containing 34 g to 92 g of activated carbon, 25 g to 76 g of a binder, 29 g to 99 g of ferric hydroxide, and 57 g to 149 g of titanium oxide.

The fourth carbon block may have an outer diameter of 45 mm to 57 mm, an inner diameter of 12 mm to 15 mm, and a length of 145 mm to 210 mm.

According to the present embodiment, while the introduced water passes through a plurality of filters 100 and 200 disposed in series, the purification may be performed in two stages.

According to the above description, the raw water introduced into the water purifier may be more reliably purified while passing through the first filter 100 and the second filter 200.

According to the present invention as described above, when the water passes through a carbon block in which activated carbon, binder, ferric hydroxide, and titanium oxide are mixed or a carbon block in which activated carbon, binder, ferric hydroxide, titanium oxide, and zero valent iron are mixed, nine kinds of heavy metals, that is, mercury, lead, copper, aluminum, iron, cadmium, arsenic, manganese and zinc may be removed.

In detail, mercury, lead, iron, aluminum, cadmium, arsenic, and copper may be removed by ferric hydroxide in the carbon blocks 120 and 310, and manganese and zinc may be removed by titanium oxide in the carbon blocks 120 and 310.

For reference, in the case of manganese and zinc contained in water, ions may be adsorbed to titanium dioxide (TiO₂) through a chemical reaction such as following Formula (14) and may be removed in water.

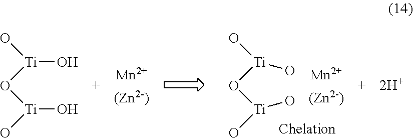

In addition, in the case of chromium and serenium, ions may be adsorbed to titanium dioxide (TiO₂) through a chemical reaction such as following Formula (15) and may be removed in water.

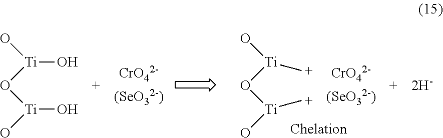

### Second Embodiment

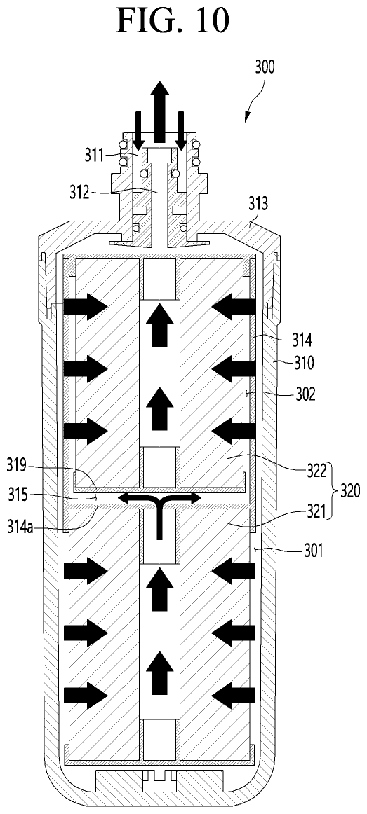

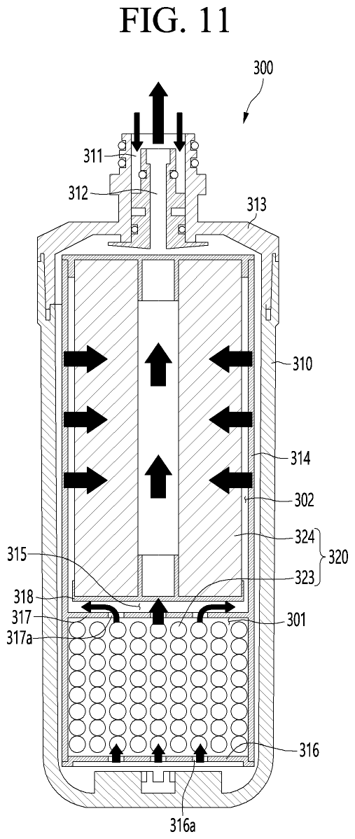

FIG. 10 is a cross-sectional view of a composite filter according to an embodiment of the present invention. Also, FIG. 11 is a cross-sectional view of a composite filter according to another embodiment of the present invention.

Referring to FIGS. 10 to 11, a filter for a water purifier according to another embodiment of the present invention may include a composite filter 300.

The filter for the water purifier according to the present invention may be provided with one composite filter 300 or a plurality of composite filters 300.

In addition, the filter for the water purifier according to the present invention may be provided by a combination of the carbon filter 100 and the composite filter 300.

The composite filter 300 may accommodate a third filter member and a fourth filter member in one filter housing 310.

An inner space of the filter housing may be divided into a first space portion defined in a lower portion thereof so that the water introduced into the filter housing is introduced and a second space portion defined above the first space portion so that the water passing through the first space portion is introduced.

The third filter member is disposed in the first space portion, and the fourth filter member is disposed in the second space portion.

The filter housing 310 includes an inlet 311 and an outlet 312. That is, water required to be purified is introduced through the inlet 311, and the purified water is discharged through the outlet 312. Thus, water is purified by the filter module 320 disposed between the inlet 311 and the outlet 312 while flowing between the inlet 111 and the outlet 112.

In addition, the filter housing 310 may define a space in which the filter module 320 is accommodated and may include an upper cap 313 in which the inlet 311 and the outlet 312 are provided. In this case, a space portion of the filter housing 310 may communicate with the outside through the inlet 311 and the outlet 312 of the upper cap 313.

When the upper cap 313 is provided as described above, the filter module 320 may be easily mounted in the space portion of the filter housing 310 by opening the upper cap 313, and thus, the filter module 320 may be easily replaced.

Water introduced into the filter housing 310 through the inlet 311 may be purified while passing through the filter module 320. That is, foreign substances (e.g., heavy metals) contained in raw water such as tap water may be removed while passing through the filter module 320.

According to the present embodiment, a filter for a water purifier that is excellent in removing the heavy metals in water, and a water purifier having the same may be provided.

For this, the filter module 320 may include carbon blocks 321 and 322, each of which is prepared by mixing activated carbon, a binder, iron hydroxide, and titanium oxide to mold a mixture in a hollow block shape.

Referring to FIGS. 10 to 11, an inner space of the filter housing 310 may include a first space portion 301 which is defined at a lower portion and into which water introduced into the filter housing 310 is introduced and a second space portion 302 which is defined above the first space portion 301 and into which the water passing through the first space portion 301 is introduced.

In addition, referring to FIG. 10, the carbon blocks 321 and 322 may include a fifth carbon block 321 accommodated in the first space portion 301 and a sixth carbon block 322 accommodated in the second space portion 302.

In addition, the fifth carbon block 321 and the sixth carbon block 322 may have different composition ratios.

For example, the fifth carbon block 321 may be prepared by containing activated carbon, a binder, ferric hydroxide, titanium oxide, and zero valent iron, and the sixth carbon block 322 may be prepared by containing activated carbon, a binder, ferric hydroxide, and titanium oxide.

The fifth carbon block may be prepared by containing 18% to 28% by weight of the activated carbon, 13% to 23% by weight of the binder, 9% to 15% by weight of the ferric hydroxide, 18% to 28% by weight of the titanium oxide, and 15% to 25% by weight of the zero valent iron.

The sixth carbon block may be prepared by containing 20% to 30% by weight of the activated carbon, 13% to 23% by weight of the binder, 10% to 20% by weight of the ferric hydroxide, and 37% to 47% by weight of the titanium oxide.

The fifth carbon block 321 may have a weight of 75 g to 170 g. In this case, the carbon block 121 may be prepared by containing 14 g to 48 g of activated carbon, 10 g to 39 g of a binder, 7 g to 26 g of ferric hydroxide, 11 g to 48 g of titanium oxide, and 11 g to 43 g of zero valent iron.

In addition, the sixth carbon block 322 may have a weight of 70 g to 130 g. In this case, the first carbon block 122 may be prepared by containing 14 g to 39 g of activated carbon, 9 g to 30 g of a binder, 7 g to 26 g of ferric hydroxide, and 48 g to 61 g of titanium oxide.

In addition, the fifth carbon block 321 may have an outer diameter of 50 mm to 57 mm, an inner diameter of 12 mm to 15 mm, and a length of 70 mm to 110 mm.

In addition, the sixth carbon block 322 may have an outer diameter of 47 mm to 50 mm, an inner diameter of 12 mm to 15 mm, and a length of 70 mm to 110 mm.

As another example, each of the third carbon block and the sixth carbon block 322 may be prepared by containing activated carbon, a binder, ferric hydroxide, and titanium oxide.

The fifth carbon block 321 may be prepared by including 20% to 30% by weight of activated carbon, 13% to 23% by weight of a binder, 29% to 39% by weight of ferric hydroxide, and 18 to 28% by weight of titanium oxide.

The sixth carbon block may be prepared by containing 20% to 30% by weight of the activated carbon, 13% to 23% by weight of the binder, 12% to 22% by weight of the ferric hydroxide, and 35% to 45% by weight of the titanium oxide.

The fifth carbon block 321 may have a weight of 85 g to 180 g. In this case, the first carbon block 122 may be prepared by containing 17 g to 54 g of activated carbon, 11 g to 41 g of a binder, 25 g to 70 g of ferric hydroxide, and 15 g to 50 g of titanium oxide.

In addition, the sixth carbon block 322 may have a weight of 70 g to 130 g. In this case, the first carbon block 122 may be prepared by containing 14 g to 39 g of activated carbon, 9 g to 30 g of a binder, 8 g to 29 g of ferric hydroxide, and 25 g to 59 g of titanium oxide.

In addition, the fifth carbon block 321 may have an outer diameter of 50 mm to 57 mm, an inner diameter of 12 mm to 15 mm, and a length of 70 mm to 110 mm.

In addition, the sixth carbon block 322 may have an outer diameter of 47 mm to 50 mm, an inner diameter of 12 mm to 15 mm, and a length of 70 mm to 110 mm.

As described above, to partition the first space portion 301 from the second space portion 302, an inner cover 314 may be provided inside the filter housing 310.

An inner space of the inner cover 314 defines a second space portion 302.

Referring to FIG. 10, the water introduced into the filter housing 310 flows downward from an upper side through a passage provided between an inner wall of the filter housing 310 and an outer wall of the inner cover 314 and then is introduced into the first space portion 301 of the filter housing 310.

Thereafter, the water flows from the outside to the inside of the fifth carbon block 321 disposed in the first space portion 301 to flow upward from a lower side through a hollow of the fifth carbon block 321.

In addition, the water flowing to the upper side of the fifth carbon block 321 is introduced into the second space portion 302 through an auxiliary passage 315 communicating with the hollow of the fifth carbon block 321.

Thereafter, the water may flow from the outside to the inside of the sixth carbon block 322 disposed in the second space portion 302 to flow upward through a hollow of the sixth carbon block 322 and then be discharged to the outside of the filter housing 310.

For reference, the auxiliary passage 315 may be integrated with a lower end of the inner cover 314 and may be defined by a space between a filter bracket 314a that supports an upper end of the fifth carbon block 321 and a filter bracket 319 that supports a lower end of the sixth carbon block 322.

Also, referring to FIG. 10, an outer diameter of the fifth carbon block 321 may be greater than an outer diameter of the sixth carbon block 322.

Referring to FIG. 11, the first space portion 301 may be filled with an anion exchange resin 323 in the form of particles, and the carbon block 324 may be accommodated in the second space portion 302.

As described above, to partition the first space portion 301 from the second space portion 302, an inner cover 314 may be provided inside the filter housing 310.

The inner cover 314 has a bottom surface 316 defined at a lower end thereof, and a plurality of through-holes 316a are defined in the bottom surface 316.

In addition, the inner cover 314 defines an intermediate wall 317 spaced apart from the bottom surface 316 at an upper side of the bottom surface 316. A plurality of through-holes 317a are defined in the intermediate wall 317.

A space between the bottom surface 316 and the intermediate wall 317 defines a first space portion 301.

Referring to FIG. 11, the water introduced into the filter housing 310 flows downward from an upper side through a passage provided between an inner wall of the filter housing 310 and an outer wall of the inner cover 314 and then is introduced into the first space portion 301 through the through-hole 316a of the bottom surface 316.

Thereafter, while passing through the anion exchange resin 323 in the form of particles disposed in the first space portion 301, the water flows upward from the lower side.

In addition, the water flowing to the upper side of the anion exchange resin 323 is discharged through a through-hole 317a of the intermediate wall 317 and then is introduced into the second space portion 302 through the auxiliary passage 315 provided between the intermediate wall 317 and the filter bracket 318 supporting the lower end of the carbon block 324.

Thereafter, the water may flow from the outside to the inside of the carbon block 324 disposed in the second space portion 302 to flow upward through a hollow of the carbon block 324 and then be discharged to the outside of the filter housing 310.

In this embodiment, the carbon block 324 may be prepared by containing activated carbon, a binder, ferric hydroxide, and titanium oxide.

The carbon block 324 may be prepared by including 25 to 30% by weight of activated carbon, 13% to 23% by weight of a binder, 27% to 37% by weight of ferric hydroxide, and 25% to 30% by weight of titanium oxide.

The carbon block 324 may have a weight of 95 g to 240 g. In this case, the first carbon block 122 may be prepared by containing 24 g to 72 g of activated carbon, 12 g to 55 g of a binder, 26 g to 89 g of ferric hydroxide, and 24 g to 72 g of titanium oxide.

In addition, the carbon block 324 may have an outer diameter of 45 mm to 57 mm, an inner diameter of 12 mm to 15 mm, and a length of 145 mm to 210 mm.

As described above, when the fifth carbon block 321 and the sixth carbon block 322 are disposed in a line in one filter housing 310, or the anion exchange resin 323 and the carbon block 324 are disposed in a line in one filter housing 310, a flow rate of the purified water may be maintained while improving filtration efficiency.

Also, it is not necessary to expand the filter installation space defined in the water purifier, and also the filter may be just applied by simply replacing the existing filter.

Also, the filter may be reduced in volume to improve space utilization, and also, slimming of the water purifier may be achieved.

According to the present embodiment, while the introduced water passes through a plurality of filters 100 and 300 disposed in series, the purification may be performed in two stages.

According to the above description, the raw water introduced into the water purifier may be more reliably purified while passing through the carbon filter 100 and the composite filter 300.

According to the present invention as described above, when the water passes through a carbon block in which activated carbon, binder, ferric hydroxide, and titanium oxide are mixed or a carbon block in which activated carbon, binder, ferric hydroxide, titanium oxide, and zero valent iron are mixed, nine kinds of heavy metals, that is, mercury, lead, copper, aluminum, iron, cadmium, arsenic, manganese and zinc may be removed.

In detail, mercury, lead, iron, aluminum, cadmium, arsenic, and copper may be removed by ferric hydroxide in the carbon blocks 120 and 310, and manganese and zinc may be removed by titanium oxide in the carbon blocks 120 and 310.

For reference, in the case of manganese and zinc contained in water, ions may be adsorbed to titanium dioxide (TiO₂) through a chemical reaction such as following Formula (16) and may be removed in water.

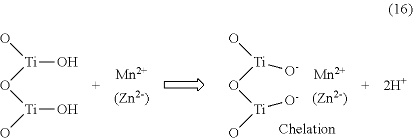

In addition, in the case of chromium and serenium, ions may be adsorbed to titanium dioxide (TiO₂) through a chemical reaction such as following Formula (17) and may be removed in water.

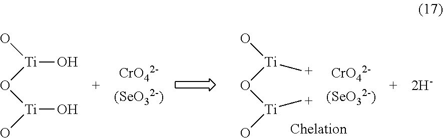

As described above, FIG. 8 is a diagram illustrating a mechanism in which chromium (Cr) and selenium (Se) are removed from an anion exchange resin. That is, chromium (Cr) and serenium (Se) contained in water may be removed while passing through the anion exchange resin by the mechanism illustrated in FIG. 8.

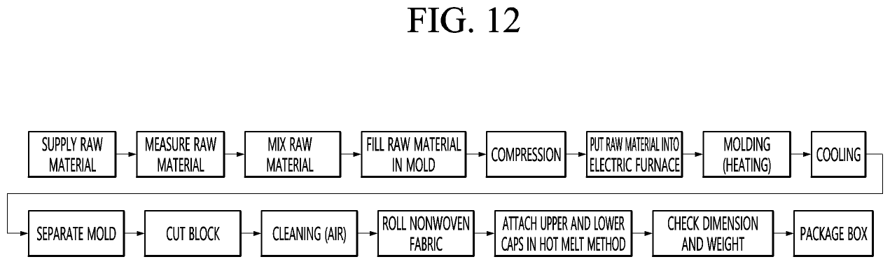

FIG. 12 is a block diagram for explaining a process of preparing a carbon block applied to the filter according to the present invention.

Referring to FIG. 12, first, each material constituting the carbon block is mixed at a moderate rate to a carbon block mixture.

For example, the carbon block mixture may be prepared by mixing activated carbon, a binder, ferric hydroxide, and titanium oxide at various ratios.

As another example, the carbon block mixture may be prepared by mixing activated carbon, a binder, ferric hydroxide, titanium oxide, and zero valent iron at various ratios.

Then, the evenly mixed carbon block mixture is filled in the mold. Then, a compression process is performed on the carbon block mixture, and then, the compressed carbon block mixture is put into an electric furnace.

Then, heating is performed. In the heating process, the binder, for example, polyethylene (PE) is melted, the activated carbon, iron hydroxide, titanium oxide, and the binder are integrally coupled, and the carbon block provided in the form of a hollow tube having overall rigidity may be molded.

Also, in the heating process, the binder, for example, polyethylene (PE) is melted, the activated carbon, ferric hydroxide, titanium oxide, the binder, and zero valent iron are integrally coupled, and the carbon block provided in the form of a hollow tube having overall rigidity may be molded.

In addition, after the heating, cooling is performed, and when the cooling is completed, the mold is separated.

In addition, the hollow tube-shaped carbon block separated from the mold may be cut to a unit length.

In addition, the cut carbon block is cleaned through injection of compressed air.

Thereafter, the nonwoven fabric around the carbon block, and the top and bottom caps are attached in a hot melt method.

Thereafter, a dimensions and weight is checked, and if there are no abnormalities, packaging is performed.

As described above, according to the present invention, there may be the effect capable of reliably removing the heavy metals in water containing chromium (Cr), selenium (Se), manganese (Mn), and zinc (Zn) in water.

According to the present invention, there may be the effect capable of removing eleven kinds of heavy metals such as lead, mercury, arsenic, cadmium, iron, aluminum, copper, manganese, zinc, chromium, and serenium in water while securing the treatment capacity.

1. A filter for a liquid purifier, the filter comprising:
a filter housing including an inlet and an outlet; and
a filter module provided in the filter housing and configured to purify liquid introduced through the inlet and to supply purified liquid to the outlet,
wherein the filter module includes:
a first filter member having a hollow tube shape; and
a second filter member provided outside the first filter member to surround an outer surface of the first filter member and including a material different from that of the first filter member.

2. The filter according to claim 1, wherein the first filter member includes a hollow first carbon block and the second filter member includes a hollow second carbon block.

3. The filter according to claim 2, wherein an outer diameter of the first carbon block and an inner diameter of the second carbon block are the same.

4. The filter according to claim 2, wherein the first carbon block and the second carbon block have respective different composition ratios.

5. The filter according to claim 2, wherein the first carbon block includes activated carbon, a binder, ferric hydroxide, and titanium oxide.

6. The filter according to claim 5, wherein the first carbon block includes 25% to 35% by weight of the activated carbon, 13% to 23% by weight of the binder, 10% to 20% by weight of the ferric hydroxide, and 32% to 42% by weight of the titanium oxide.

7. The filter according to claim 5, wherein the first carbon block includes 10% to 20% by weight of the activated carbon, 13% to 23% by weight of the binder, 10% to 57% by weight of the ferric hydroxide, and 10% to 57% by weight of the titanium oxide.

8. The filter according to claim 2, wherein the second carbon blocks includes activated carbon, a binder, ferric hydroxide, titanium oxide, and zero valent iron.

9. The filter according to claim 8, wherein the second carbon block includes 25% to 35% by weight of the activated carbon, 13% to 23% by weight of the binder, 1% to 10% by weight of the ferric hydroxide, 1% to 10% by weight of the titanium oxide, and 37% to 47% by weight of the zero valent iron.

10. The filter according to claim 2, wherein the second carbon block includes 23% to 33% by weight of activated carbon, 13% to 23% by weight of a binder, 8% to 46% by weight of ferric hydroxide, and 8% to 46% by weight of titanium oxide.

11. The filter according to claim 1, wherein the first filter member includes a hollow carbon block, and
the second filter member includes an anion exchange resin nonwoven fabric configured to surround an outside of the carbon block.

12. The filter according to claim 11, wherein the carbon block includes 20% to 28% by weight of activated carbon, 13% to 23% by weight of a binder, 14% to 24% by weight of ferric hydroxide, and 33% to 43% by weight of titanium oxide.

13. A filter for a liquid purifier, the filter comprising:
a first filter including:
a first filter housing having a first inlet and a first outlet, and
a first filter module provided in the first filter housing and configured to purify liquid introduced through the first inlet and to supply purified liquid to the first outlet; and
a second filter including:
a second filter housing having a second inlet and a second outlet, and
a second filter module provided in the second filter housing and configured to purify liquid introduced through the second inlet and to supply purified liquid to the second outlet,
wherein the first filter and the second filter are provided in series, and liquid discharged through the first outlet is introduced to the second inlet.

14. The filter according to claim 13, wherein the first filter module includes a hollow first carbon block including activated carbon, a binder, ferric hydroxide, titanium oxide, and zero valent iron.

15. The filter according to claim 14, wherein the first carbon block includes 25% to 35% by weight of the activated carbon, 13% to 23% by weight of the binder, 5% to 15% by weight of the ferric hydroxide, 18% to 28% by weight of the titanium oxide, and 10% to 20% by weight of the zero valent iron.

16. The filter according to claim 13, wherein the second filter module includes a hollow second carbon block including activated carbon, a binder, ferric hydroxide, and titanium oxide.

17. The filter according to claim 16, wherein the second carbon block includes 18% to 28% by weight of the activated carbon, 13% to 23% by weight of the binder, 15% to 30% by weight of the ferric hydroxide, and 30% to 45% by weight of the titanium oxide.

18. A filter for a liquid purifying, the filter comprising:
a filter housing including an inlet and an outlet; and
a filter module provided in the filter housing and configured to purify liquid introduced through the inlet and to supply purified liquid to the outlet,
wherein an inner space of the filter housing includes:
a first space defined in a lower portion of the filter housing to receive liquid introduced into the filter housing; and
a second space defined above the first space to receive liquid that has passed through the first space,
wherein the filter module includes:
a first filter member provided in the first space; and
a second filter member provided in the second space.

19. The filter according to claim 18, wherein the first filter member and the second filter member include a hollow first carbon block and a hollow second carbon block, respectively.

20. The filter according to claim 19, wherein the first carbon block and the second carbon block have respective different composition ratios.

21. The filter according to claim 19, wherein an outer diameter of the first carbon block is greater than an outer diameter of the second carbon block.

22. The filter according to claim 19, wherein the first carbon block includes activated carbon, a binder, ferric hydroxide, titanium oxide, and zero valent iron.

23. The filter according to claim 22, wherein the first carbon block includes 18% to 28% by weight of the activated carbon, 13% to 23% by weight of the binder, 9% to 15% by weight of the ferric hydroxide, 18% to 28% by weight of the titanium oxide, and 15% to 25% by weight of the zero valent iron.

24. The filter according to claim 22, wherein the second carbon block includes 20% to 30% by weight of the activated carbon, 13% to 23% by weight of the binder, 10% to 20% by weight of the ferric hydroxide, and 37% to 47% by weight of the titanium oxide.

25. The filter according to claim 19, wherein each of the first carbon block and the second carbon block includes activated carbon, a binder, ferric hydroxide, and titanium oxide.

26. The filter according to claim 25, wherein the first carbon block includes 20% to 30% by weight of the activated carbon, 13% to 23% by weight of the binder, 29% to 39% by weight of the ferric hydroxide, and 18% to 28% by weight of the titanium oxide.

27. The filter according to claim 25, wherein the second carbon block includes 20% to 30% by weight of the activated carbon, 13% to 23% by weight of the binder, 12% to 22% by weight of the ferric hydroxide, and 35% to 45% by weight of the titanium oxide.

28. The filter according to claim 18, wherein the first filter member includes anion exchange resin particles provided in the first space, and
the second filter member includes a carbon block provided in the second space.

29. The filter according to claim 28, wherein the carbon block includes 25% to 30% by weight of activated carbon, 13% to 23% by weight of a binder, 27% to 37% by weight of ferric hydroxide, and 25% to 30% by weight of titanium oxide.

30. The filter according to claim 18, wherein the filter housing includes an inner cover configured to define an inner space to accommodate the second filter member.

31. The filter according to claim 18, wherein the filter housing includes an inner cover configured to define an inner space to accommodate the first filter member and the second filter member, and
the inner cover defines an intermediate wall configured to partition the first space from the second space.

32. A liquid purifier comprising the filter according to claim 1.
